(19) United States
(12) Patent Application Publication
(10) Pub. No.: US 2025/0276375 A1
(43) Pub. Date: Sep. 4, 2025

(54) SPATTER MONITORING FOR ADDITIVE MANUFACTURING SYSTEMS

(71) Applicants: Rolls-Royce Corporation, Indianapolis, IN (US); Rolls-Royce plc, London (GB)

(72) Inventors: Scott Nelson, Indianapolis, IN (US); David James Puhl, Indianapolis, IN (US); Clive Grafton-Reed, London (GB); Peter E. Daum, Indianapolis, IN (US); Robert F. Proctor, Indianapolis, IN (US); Christopher Paul Heason, London (GB)

(21) Appl. No.: 18/593,389

(22) Filed: Mar. 1, 2024

(51) Int. Cl. B22F 10/85; B22F 10/322; B22F 10/34; B22F 12/90; B33Y 10/00; B33Y 30/00; B33Y 50/02; B33Y 80/00

(52) U.S. Cl. CPC B22F 10/85; B22F 10/322; B22F 10/34; B22F 12/90; B33Y 10/00; B33Y 30/00; B33Y 50/02; B33Y 80/00

(57) ABSTRACT

An additive manufacturing system includes an energy delivery device configured to deliver energy to a build surface of a component to form a melt pool in the build surface of the component, a powder delivery device configured to direct a powder stream toward the melt pool, a spatter monitoring system, and a computing device configured to receive image data from the spatter monitoring system. The spatter monitoring system is configured to capture image data indicative of spatter, wherein spatter is material ejected from the melt pool. The computing device is configured to identify a spatter event based on the received image data and control at least one of the energy delivery device or the powder delivery device based on the determined spatter event.

### TECHNICAL FIELD

The disclosure relates to additive manufacturing systems and techniques.

### BACKGROUND

Additive manufacturing systems generate three-dimensional structures through addition of material layer-by-layer or volume-by-volume to form the structure, rather than removing material from an existing component to generate the three-dimensional structure. Additive manufacturing processes may be advantageous in many situations, such as rapid prototyping, forming components with complex three-dimensional structures, or the like. In some examples, additive manufacturing processes may utilize powdered materials, and may melt or sinter the powdered material together in predetermined shapes to form the three-dimensional structures. Variations in process conditions may result in defects and differences in microstructure in the three-dimensional structures.

### SUMMARY

The disclosure describes additive manufacturing systems, and methods for operating additive manufacturing systems, that fabricate a component according to deposition parameters. An additive manufacturing system includes an energy delivery device that delivers energy to a build surface of a component to form a melt pool and a powder delivery device that directs a powder stream toward the melt pool. Spatter is material ejected from the melt pool, which may be liquid or at least partially melted. Spatter may be generated as a result of, for example, surface tension disruption of the melt pool and/or melt pool vaporization (e.g., pluming). Adverse effects may result from spatter, such as melted or partially melted material ejected from the melt pool adhering to the build surface and impacting the build quality of the layer, and/or spatter adhering to a delivery nozzle and interrupting the flow of the powder stream, or the like. Systems and techniques according to the present disclosure may include a spatter monitoring system and a computing device. The spatter monitoring system may capture image data indicative of spatter, and the computing device may identify spatter in the received image data and identify a spatter event based on the identified spatter. The computing device may control the powder delivery device and/or the energy delivery device based on the determined spatter event, such as by adjusting one or more parameters related to the powder delivery device (e.g., a carrier gas flow rate, a powder mass flow rate, or the like) and/or one or more parameters related to the energy delivery device (e.g., a focus or a power supplied to the energy delivery device, or the like). The computing device may further determine a relationship between the spatter event and either the deposition parameters that create the spatter event or the material parameters that result from the spatter event, such as by using machine learning techniques, that may be used to control the additive manufacturing system in the same or subsequent additive manufacturing processes. In this way, additive manufacturing systems described herein may control spatter to produce layers with improved build quality.

In some examples, the disclosure describes an additive manufacturing system which includes an energy delivery device configured to deliver energy to a build surface of a component to form a melt pool in the build surface of the component, a powder delivery device configured to direct a powder stream toward the melt pool, a spatter monitoring system configured to capture image data indicative of spatter, wherein spatter is material ejected from the melt pool, and a computing device. The computing device is configured to receive the image data from the spatter monitoring system, identify spatter in the received image data, identify a spatter event based on the identified spatter, and control at least one of the energy delivery device or the powder delivery device based on the determined spatter event.

In some examples, the disclosure describes a method for additive manufacturing that includes delivering, via an energy delivery device of an additive manufacturing system, energy to a build surface of a component to form a melt pool in the build surface of the component. The method includes delivering, via a powder delivery device of the additive manufacturing system, a powder stream toward the melt pool. The method further includes receiving, by a computing device, image data indicative of spatter from a spatter monitoring system of the additive manufacturing system, wherein spatter is material ejected from a melt pool formed on a component being manufactured by an additive manufacturing system. The method includes identifying, by the computing device, spatter in the received image data, and based on the identified spatter data, identifying a spatter event, and controlling, by the computing device and based on the determined spatter event, at least one of the powder delivery device or the energy delivery device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a conceptual block diagram illustrating example spatter monitoring aspects of an example additive manufacturing system.

FIG. 1B is a conceptual block diagram illustrating example spatter monitoring image sensors of a spatter monitoring system and spatter analysis modules of a computing device of an additive manufacturing system.

FIG. 2 is a process flow diagram illustrating a mass flux and heat flux monitoring and control technique.

FIG. 3 is a flowchart illustrating an example method for fabricating a component using spatter monitoring.

FIG. 4A is a conceptual diagram illustrating an example machine learning model.

FIG. 4B is a conceptual diagram illustrating an example training process for a machine learning model.

FIG. 5A is a conceptual and schematic diagram illustrating a portion of an example an additive manufacturing system during an additive manufacturing technique that does not use spatter monitoring.

FIG. 5B is a conceptual and schematic side view diagram illustrating an example additively-manufactured component formed during the additive manufacturing technique of FIG. 5A.

FIG. 6A is a conceptual and schematic diagram illustrating a portion of the example additive manufacturing system during an additive manufacturing technique that employs spatter monitoring and control.

FIG. 6B is a conceptual and schematic side view diagram illustrating an example additively-manufactured component formed during the additive manufacturing technique of FIG. 6A.

### DETAILED DESCRIPTION

The disclosure generally describes techniques and systems for monitoring spatter during a blown powder additive manufacturing technique, such as a directed energy deposition (DED) technique, and using an imaged spatter event to control fabrication of a component. During blown powder additive manufacturing, a component is built up by adding material in sequential layers, such that the final component is composed of a plurality of layers of material. In blown powder additive manufacturing techniques for forming components from metals or alloys, an energy source may direct energy at a substrate to form a melt pool, and a powder delivery device may deliver a powder to the melt pool. At least some of the powder at least partially melts and is joined to the melt pool and, thus, the substrate.

Challenges may arise when performing additive manufacturing techniques with additive manufacturing systems. For example, spatter, which may be material ejected from the melt pool may adhere to undesired surfaces. Spatter may be generated in one or more spatter events, or continuously, as a result of one or more of a surface tension disruption (e.g., pressure imbalance between the melt pool and coverage gas), a vaporization of the melt pool (e.g., pluming), or the like. The spatter event or events may indicate an unstable process that generally results in a lower quality build. For example, the spatter, which may be melted or partially melted powder, may adhere to one or more surfaces away from the melt pool, and may cause deleterious impacts. Spatter may adhere to the build surface of the component and cause a deposition anomaly, such as a defect in the topology of the build surface. Additionally, or alternatively, spatter may adhere to deposition equipment (e.g., a delivery nozzle) where it may interrupt delivery of the powder stream or the energy to the build surface, or may agglomerate and eventually fall off onto the build surface.

In accordance with aspects of this disclosure, an additive manufacturing system includes a spatter monitoring system. The spatter monitoring system includes one or more image sensors for capturing image data near the melt pool. The captured image data may be delivered to and received by a computing device. The computing device may identify, in the captured image data, a spatter event where material is ejected from the melt pool, and the computing device may adaptively control deposition based on the spatter event. For example, the computing device may, based on the determined spatter event, adjust one or more operational settings of the powder delivery device, the energy delivery device, or both.

In some examples, no spatter may be permitted, and any amount of material, however small, ejected from the melt pool may be identified as a spatter event. Alternatively, in some examples, a certain amount of spatter may be continuous, or unavoidable, or acceptable (e.g., determined to not interfere with the build). In such examples, the computing device may determine that the captured image data is indicative of spatter that exceeds a threshold (e.g., a non-zero threshold) for causing one or more deposition anomalies. Put differently, the computing device may determine that minor spatter does not constitute a spatter event, and only identify problematic amounts, distributions, or sizes of spatter (e.g., those that cause a deposition anomaly such as a topological feature on the build surface or buildup on a deposition head or delivery nozzle) to constitute a spatter event. Accordingly, the computing device may be configured to determine whether sensed spatter exceeds a threshold for causing deposition anomalies, and control the energy delivery device and/or the powder delivery device to reduce a magnitude or occurrence of the one or more deposition anomalies by reducing a magnitude or occurrence of the spatter. The computing device may use the determined spatter event to select or adjust deposition parameters to produce a layer having the desired parameters. In this way, additive manufacturing systems may more accurately produce a layer having the desired parameters compared to systems that so not use spatter monitoring to control deposition parameters.

The powder delivery device may be separate and discrete from each other, or may be combined as parts of a common deposition head. When parts of a common deposition head, the computing device may control the common deposition head to travel along a toolpath across the build surface to deposit a layer. In some examples, the computing device may also individually control the relative position of the powder stream to the melt pool by individually controlling the position of the powder delivery device and/or the energy delivery device within the common deposition head. For example, the computing device may determine that a spatter event has occurred or is occurring, and may adjust the position of the powder delivery device and/or the energy delivery device to reduce or eliminate spatter. In some cases, the deposition head may define a central longitudinal axis. The energy may be delivered coincident with or parallel to the central longitudinal axis.

In examples where the powder delivery device and the energy delivery device are parts of a common deposition head, the computing device may control the toolpath of the deposition head to account for spatter. For example, the computing device may adjust the toolpath to avoid (e.g., swerve around) a deposition anomaly. In some examples, the computing device may cause the deposition head to re-do (e.g., travel back over) a layer that contains spatter adhered to the layer with just the energy delivery device activated and without delivering powder to the melt pool. In this way, the computing device may cause the energy delivery device to scan a layer that contains spatter adhered to the build surface to re-melt and smooth a deposition anomaly caused by the spatter.

In some examples, the spatter monitoring system includes one or more image sensors configured to capture image data indicative of spatter. For example, the spatter monitoring system may include a melt pool monitor, which may be a thermal camera configured to observe the melt pool and capture infrared image data. The captured infrared image data captured by material ejected from the melt pool as spatter. In some examples, the spatter monitoring system may additionally, or alternatively, include one or more visual cameras configured to capture visual light (e.g., visible light) image data. Inclusion of multiple image sensors which capture different image data and/or are positioned to observe the melt pool at different distances or focuses with respect to the melt pool may be advantageous for capturing image data related to more types of spatter events or a more complete picture of a spatter event. Furthermore, captured image data by more than one type of camera (e.g., both infrared and visual spectra) may be advantageous to determination of more types of spatter events or a more complete picture of a spatter event.

As mentioned above, the additive manufacturing system may include a common deposition head, of which the energy delivery device are both components. The deposition head may define a central longitudinal axis. In some examples, one or more image sensors of the spatter monitoring system may be positioned on the central longitudinal axis, which may be referred to as an “on-axis” position. Positioning an image sensor on-axis may be advantageous for determining whether spatter will land outside of the surface of the melt pool, and thus cause a deposition anomaly.

However, it may be difficult to identify spatter using a spatter monitoring system which includes only an on-axis image sensor. For example, hot droplets of liquid positioned above the melt pool may not be identifiable by the computing device within the image data captured only by an on-axis image sensor. According to one or more examples of the present disclosure, spatter monitoring systems may include one or more image sensors that are not positioned on the central longitudinal axis of the deposition head, which may be called an “off-axis” position. Advantageously, such an off-axis image sensor may, on its own or in combination with an on-axis image sensor, capture image data the is indicative of more types of spatter events of capture image data that more completely describes certain types of spatter events than spatter monitoring systems that use only an on-axis image sensor. For example, an off-axis image sensor may capture, and the computing device may identify and characterize, for example a spatter event that results in spatter building up on a delivery nozzle, which may not be recognized by a spatter monitoring system that includes only an on-axis image sensor.

The computing device or devices may be configured to control the powder delivery device and/or the energy delivery device according to a set of deposition parameters. For example, the computing device may set parameters controllable by the powder delivery device that include one or more of a carrier gas flow rate, a powder mass flow rate, and a delivery nozzle angle. Similarly, the computing device may set parameters controllable by the energy delivery device to deposit a layer. The parameters controllable by the energy delivery device may include one or more of a focus of the energy delivery device, a power supplied to the energy delivery device, and the like. Responsive to determining that a spatter event has occurred or is occurring, the computing device may adjust one or more parameters controllable by the powder delivery device and/or may adjust one or more parameters controllable by the energy delivery device. The adjustment(s) may reduce a magnitude or frequency of occurrence of the spatter event or spatter events.

In one specific example, the deposition head may travel back and forth across the build surface laying down a series of adjacent tracks to deposit a layer on the build surface. As such, the deposition head may dwell at the ends of the track for a longer period of time than other portions of the track because the deposition head must slow down and change direction. At these portions of the track, the energy delivered may overheat and vaporize the melt pool, causing a spatter event. In some examples, the computing device may adjust the parameters of the energy delivery device by decreasing the power supplied to the melt pool to prevent overheating the melt pool and thus reduce the magnitude or occurrence of the spatter event. Other example causes of spatter events and control mechanisms to reduce their magnitude or occurrence are also considered.

Control (e.g., adjustment of parameters) of the powder delivery device and/or the energy delivery device in response to spatter may be performed in one or more ways by the computing device. In some examples, preset adjustments (e.g., slowing of the deposition head traveling down the toolpath, or reduction of the power supplied to the energy delivery device, or reduction of the mass flow rate of the powder, or the like) may be conducted, for example iteratively until the spatter event concludes. In some examples, the computing device may store a lookup table which stores both types or categories of spatter events and adjustments to settings of the powder energy delivery device and/or the energy delivery device. The computing device may perform an adjustment to the powder delivery device and/or the energy delivery device based on the recommended adjustment from the lookup table.

In one or more examples of the disclosure, the computing device may determine, via a machine learning model that takes the image data from the spatter monitoring system as input, one or more deposition parameters of the powder delivery device and/or the energy delivery device using one or more machine learning techniques. In this way, the computing device may be trained to execute adjustments to the settings of the powder delivery device and/or the energy delivery device based on previous spatter events and adjustments that were made to reduce or eliminate the frequency and/or magnitude of such spatter events.

Additive manufacturing systems and techniques of the present disclosure may be used to form any suitable component. For example, the additively-manufactured component may be a component of a gas turbine engine, or an additively-manufactured coating on a gas turbine engine component. Forming components or coatings of gas turbine engines in this way may reduce material waste, provide for increased quality, and/or impart desired temper, microstructure, or other material properties relative to gas turbine engine components formed by other manufacturing processes.

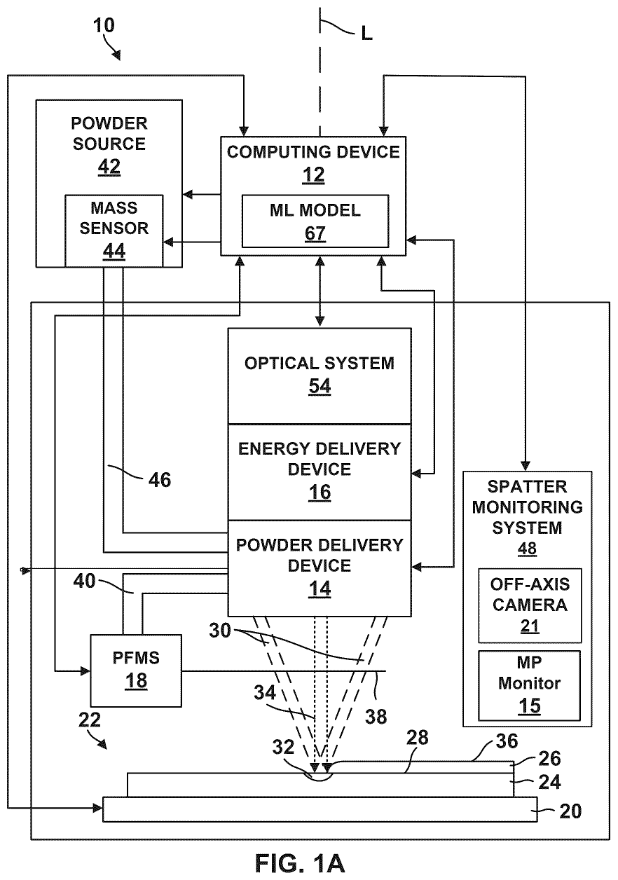

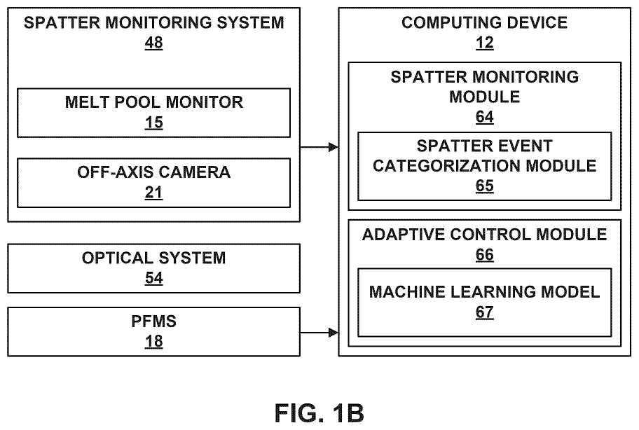

FIG. 1A is a conceptual block diagram illustrating an example additive manufacturing system 10 configured to monitor a gas flow during an additive manufacturing technique. In the example illustrated in FIG. 1A, additive manufacturing system 10 includes a computing device 12, a powder delivery device 14, an energy delivery device 16, a powder flow monitoring system (PFMS) 18, an optical system 54, a stage 20, a powder source 42, a powder source mass sensor 44, and a spatter monitoring system 48.

Stage 20 is configured to position component 22 during an additive manufacturing process. In some examples, stage 20 is movable relative to energy delivery device 16 and/or energy delivery device 16 is movable relative to stage 20. Similarly, stage 20 may be movable relative to powder delivery device 14 and/or powder delivery device 14 may be movable relative to stage 20. Stage 20 may be configured to selectively position and restrain component 22 in place relative to stage 20 during manufacturing of component 22.

Powder source 42 is the source of powder for powder stream 30. Powder source 42 may include any suitable container or enclosure, such as a hopper, configured to hold powder. Powder source 42 also may include mechanism for entraining the powder in a gas flow. For instance, powder source 42 may be coupled to a gas source, which provides a gas flowing through powder source 42 and entraining powder within the gas flow. Additionally, or alternatively, powder source 42 may include an agitator configured to agitate the powder and increase entrainment of the powder in the gas stream. System 10 may include a powder source mass sensor 44 associated with powder source 42. Powder source mass sensor 44 may be configured to quantify loss of mass in the powder source 42 or, alternatively, a mass flow out of powder source 42.

Powder source 42 is fluidically coupled to powder delivery device 14 via a flow path 46. Flow path 46 may include any suitable structure(s) defining an enclosed flow between powder source 42 and powder delivery device, including conduit, pipe, tubes, or the like. Although not shown in FIG. 1A, for at least part of flow path 46 between powder source 42 and nozzles of powder delivery device 14, flow path 46 may split into multiple, parallel sections, e.g., one for each nozzle. Further, although not shown in FIG. 1A, in some examples, flow path 46 may include one or more nozzles for controlling flow through flow path 46 as a whole or portions of flow path 46 (e.g., a section associated with a particular nozzle of powder delivery device 14).

Powder delivery device 14 may be configured to deliver powder to selected locations of component 22 being formed via a powder stream 30. Powder delivery device 14 may include one or more nozzles that each output powder and gas flow, such that the combined powder and gas flow defines powder stream 30 focused at a focus plane. The gas flow may include an inert gas, such as argon or nitrogen gas, that maintains an inert atmosphere near melt pool 32. As powder delivery device 14 is movable in the z-axis shown in FIG. 1A relative to component 22, the focal plane of powder delivery device 14 also may be movable in the z-axis relative to component 22, such that the focus plane may be controlled to be substantially coincident with build surface 28.

In some examples, powder delivery device 14 may be mechanically coupled or attached to energy delivery device 16 to facilitate delivery of powder stream 30 and energy 34 for forming melt pool 32 to substantially the same location adjacent to component 22. In some examples, powder delivery device 14 and energy delivery device 16 may be parts of a common deposition head. Energy delivery device 16 may include an energy source, such as a laser source, an electron beam source, plasma source, or another source of energy that may be absorbed by component 22 to form a melt pool 32 and/or be absorbed by powder in powder stream 30 to be added to component 22. Example laser sources include a CO laser, a CO₂ laser, a Nd:YAG laser, or the like. In some examples, the energy source may be selected to provide energy with a predetermined wavelength or wavelength spectrum that may be absorbed by component 22 and/or the powder to be added to component 22 during the additive manufacturing technique.

In some examples, energy delivery device 16 also includes an energy delivery head, which is operatively connected to the energy source. The energy delivery head may aim, focus, or direct energy 34 toward predetermined positions at or adjacent to a surface of component 22 during the additive manufacturing technique. As described above, in some examples, the energy delivery head may be movable in at least one dimension (e.g., translatable and/or rotatable) under control of computing device 12 to direct the energy toward a selected location at or adjacent to a surface of component 22. In some examples, energy delivery device 16 may be translatable and/or rotatable in three dimensions.

As shown in FIG. 1A, energy delivery device 16 may be arranged or configured such that energy 34 and powder stream 30 both exit from a common deposition head and are directed toward build surface 28. For instance, energy 34 may pass through a central channel within the deposition head and exit a central aperture in the deposition head, while fluidized powder may flow through internal channels and powder delivery nozzle(s) for forming powder stream 30 and directing powder stream 30 toward build surface 28. At least some of the powder in powder stream 30 may impact a melt pool 32 in component 22, and at least some of the powder that impacts melt pool 32 may be joined to component 22.

During additive manufacturing, component 22 is built up by adding material to component 22 in sequential layers. The final component is composed of a plurality of layers of material. Energy delivery device 16 may direct energy 34 at first layer 24 to form melt pool 32. Powder delivery device 14 may deliver powder stream 30 to melt pool 32, where at least some of the powder at least partially melts and is joined to first layer 24. Melt pool 32 cools as energy 34 is no longer delivered to that location of first layer 24 (e.g., due to energy delivery device 16 scanning energy 34 over the surface of first layer 24). In this way the deposition head may traverse across build surface 28 (e.g., back and forth across build surface 28) depositing tracks of material which form layer 26.

System 10 may include both mass flow monitoring and heat flow monitoring. To provide mass flow monitoring, system 10 may include powder flow monitoring system (PFMS) 18. PFMS 18 is configured to image at least a portion of powder stream 30 to detect powder flowing between powder delivery device 14 and build surface 28. For example, PFMS 18 may include an illumination device and an imaging device. In some examples, the illumination device may include one or more light sources. For instance, the illumination device may include one or more structured light devices, such as one or more lasers. The illumination device is configured to illuminate a plane of powder stream 30 at image plane 38, e.g., a plane substantially perpendicular to an axis extending between powder delivery device 14 and build surface 28. The imaging device of PFMS 18 is configured to image at least some of the illuminated powder. The imaging device may have a relatively high data acquisition speed (e.g., frame rate), such greater than 1000 Hz.

To provide heat flow monitoring, system 10 may include one or more thermal image sensors configured to image at least a portion of melt pool 32 to detect parameters, such as size, temperature, or shape, of melt pool 32. For example, a thermal sensor may be communicatively coupled to optical system 54 for observing thermal emissions around melt pool 32 and the same or a different thermal camera may monitor a size and/or temperature of melt pool 32. Optical system 54 may include an imaging device and an associated optical train, which senses emissions at or near component 22 during the additive manufacturing technique. For example, optical system 54 may include a visible light imaging device, an infrared imaging device, or an imaging device that is configured (e.g., using a filter) to image a specific wavelength or wavelength range. The optical train may include one or more reflective, refractive, diffractive optical components configured to direct light to the imaging device. For example, the optical train may be configured to direct light from near component 22 and/or melt pool 32 to the imaging device.

In addition to mass flow monitoring and heat flow monitoring, system 10 includes spatter monitoring system 48. Spatter monitoring system 48 may capture image data indicative of spatter. Spatter is material, such as solid powder, partially melted powder, or liquid material, that has been ejected from melt pool 32. The image sensor or sensors of spatter monitoring system 48 may be indicative of spatter by being pointed at or above the surface of melt pool 32 to capture spatter when the spatter is airborne. Furthermore, the image sensor or sensors may be configured with a relatively fast shutter speed, such that the airborne spatter may be captured and analyzed. In some examples, the shutter speed may be 1/8000, or may be even faster to capture the spatter as frozen in a single place in the image data.

For example, spatter may be droplets of the melted layer 24 that form melt pool 32. As used herein, ejected from melt pool 32 means material displaced from melt pool 32, such as airborne material of material deposited discretely on other portions of build surface 28 or other parts of system 10, such as powder delivery device 14 or energy delivery device 16, where, among other problems, spatter may accumulate and eventually fall off onto build surface 28.

System 10 may monitor spatter using spatter monitoring system 48 to reduce or avoid formation of deposition anomalies that may result from variation in effects, such as surface tension disruption of melt pool 32, caused by parameters related to coverage gas flow, powder stream 30 and energy beam 34. For example, the combination of settings of system 10 that include the mass flow rate of powder in powder stream 30, the energy density and focus of energy beam 34, the travel speed of powder delivery device 14 and/or energy delivery device 16 along a toolpath, and the like, may result in melt pool vaporization, which may in turn cause pluming where material is ejected due to boiling or frothing in the melt pool. Other causes of spatter in melt pool 32 are also considered. In any event, spatter indicates an unstable process that may result in one or more of delivery nozzle blockage, machine damage, component contamination, or the like.

To provide spatter monitoring, spatter monitoring system 48 may include melt pool (MP) monitor 15 and/or off-axis camera 21, which may be the image sensors that capture image data indicative of spatter. In some examples, other numbers of image sensors may be used, for example a single image sensor, two image sensors, three image sensors, four image sensors, or even five image sensors. Spatter monitoring system 48 including multiple image sensors may be advantageous, because computing device 12 may be able to analyze and/or synthesize views of melt pool 32 at different angles and/or different zooms to identify and characterize spatter events, offering a more complete characterization and/or categorization of a spatter event.

In the illustrated example, MP monitor 15 is a thermal camera configured to capture infrared image data, and off-axis camera 21 is configured to capture visual light data. It may be advantageous to include both image sensors configured to capture visual light and infrared cameras configured to capture infrared image data. In this way, computing device 12 may be able to analyze and/or synthesize views of melt pool 32 from different modes to identify and characterize spatter events, offering a more complete characterization and/or categorization of a spatter event.

As mentioned above, energy delivery device 16 and powder delivery device 14 may be parts of a common deposition head that defines central longitudinal axis L. In the illustrated example, both MP monitor 15 and off-axis camera 21 are displaced from central longitudinal axis L in an “off-axis” configuration. In other examples, MP monitor 15 may be positioned on axis, where MP monitor 15 may be considered a part of both spatter monitoring system 48 and optical system 54. Positioning at least one image sensor of spatter monitoring system 48 may advantageously allow for detection of spatter deposited on powder delivery device 14, energy delivery device 16, or another part of system 19. As will be described further below, spatter event(s) captured by spatter monitoring system 48 may be correlated to anomalous or undesirable events and/or used to control powder delivery device 14 and/or energy delivery device 16 in a manner that reduces or avoid the anomalous or undesirable events.

Computing device model 12 includes machine learning (ML) model 67. In some examples, ML model 67 may receive image data captured by MP monitor 15 and/or off-axis camera 21 as inputs to the machine learning model. In addition to data from MP monitor 15 and off-axis camera 21, ML model 67 may receive data from optical system 54, PFMS 18, and/or other parameters (settings of powder delivery device 14, settings of energy delivery device 16, or other sensed data or settings of system 10).

Computing device 12 is configured to control components and operation of system 10 and may include, for example, a desktop computer, a laptop computer, a workstation, a server, a mainframe, a cloud computing system, or the like. Computing device 12 may be communicatively coupled to, and configured to control, powder delivery device 14, energy delivery device 16, PFMS 18, optical system 54, stage 20, powder source 42, powder source mass sensor 44, and/or spatter monitoring system 48 using respective communication connections. Although FIG. 1A illustrates a single computing device 12 and attributes all control and processing functions to that single computing device 12, in other examples, system 10 may include multiple computing devices 12, e.g., a plurality of computing devices 12.

Computing device 12 may be configured to control operation of powder delivery device 14, energy delivery device 16, adjustable z-stage 40, and/or stage 20, to position component 22 relative to powder delivery device 14, energy delivery device 16, PFMS 18, and/or spatter monitoring system 48 during additive manufacturing processes. For example, as described above, computing device 12 may control stage 20 and powder delivery device 14, energy delivery device 16, and/or adjustable z-stage 40 to translate and/or rotate along at least one axis to position component 22 relative to powder delivery device 14, energy delivery device 16, PFMS 18, and/or spatter monitoring system 48. Positioning component 22 relative to powder delivery device 14, energy delivery device 16, PFMS 18, and/or spatter monitoring system 48 may include positioning a predetermined surface (e.g., build surface 28 to which material is to be added) of component 22 in a predetermined orientation relative to powder delivery device 14, energy delivery device 16, and/or spatter monitoring system 48.

Computing device 12 may be configured to control system 10 to deposit layers 24 and 26 to form component 22 based on a set of deposition parameters. The set of deposition parameters may include energy, feed, and motion parameters that are configured to produce layers 24, 26, having various physical parameters, such as a height of layers 24, 26, and a density of layers 24, 26. For example, the set of deposition parameters may include power supplied, beam diameter (focus), beam profile, and wavelength of energy delivery device 16; powder feed rate and gas feed rate of powder delivery device 14; scan speed and deposition path of stage 20 relative to energy delivery device 16 and powder delivery device 14; or any other operating parameters that may affect an amount and/or quality of material formed as layers 24, 26.

Computing device 12 may be configured to select deposition parameters that are configured to generate layers 24, 26, according to the desired physical parameters. As shown in FIG. 1A, component 22 may include a first layer 24 and a second layer 26, although many components may be formed of additional layers, such as tens of layers, hundreds of layers, thousands of layers, or the like. Component 22 in FIG. 1A is simplified in geometry and the number of layers compared to many components formed using additive manufacturing techniques. Although techniques are described herein with respect to component 22 including first layer 24 and second layer 26, the technique may be extended to components 22 with more complex geometry and any number of layers.

To form component 22, computing device 12 may control powder delivery device 14 and energy delivery device 16 according to the set of operating parameters to form, on build surface 28 of first layer 24 of material, a second layer 26 of material. Computing device 12 may control energy delivery device 16 to deliver energy beam 34 to a volume at or near surface 28 to form melt pool 32. For example, computing device 12 may control the relative position of energy delivery device 16 and stage 20 to direct energy to the volume. Computing device 12 also may control powder delivery device 14 to deliver powder stream 30 to melt pool 32. For example, computing device 12 may control the relative position of powder delivery device 14 and stage 20 to direct powder stream 30 at or on to melt pool 32.

Computing device 12 may control powder delivery device 14 and energy delivery device 16 to move energy 34 and powder stream 30 along build surface 28 in a pattern until layer 26 is complete. Computing device 12 may then control a z-axis position of stage 20 and/or powder delivery device 14 and energy delivery device 16 such that melt pool 32 will be formed on surface 36 of second layer 26, and may control powder delivery device 14 and energy delivery device 16 to move energy 34 and powder stream 30 along build surface 28 in a pattern until layer 26 is complete.

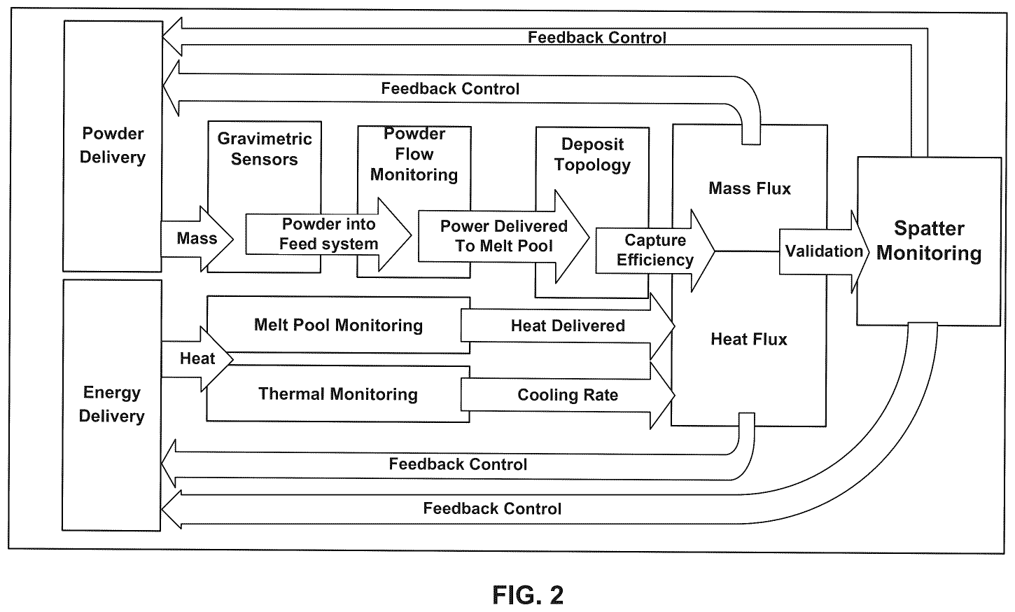

As mentioned above, system 10 may be configured with various in-situ monitoring techniques, including mass flux monitoring, heat flux monitoring, and gas flow monitoring, to control an additive manufacturing process and a subsequent subtractive manufacturing process. FIG. 2 is a process flow diagram illustrating a mass flux and heat flux monitoring and control technique. The technique of FIG. 2 may be implemented by system 10 of FIG. 1A and will be described with concurrent reference to FIG. 1A.

Computing device 12 may be configured to control a powder feed rate output by powder source 42 (see top left of FIG. 2). For instance, computing device 12 may be configured to control an agitator of powder source 42, a gas flow rate of gas flowing through powder source 42, a position of one or more valves within flow path 46, or the like to control a powder feed rate output by powder source 42. Computing device 12 may be configured to receive data from one or more mass flow monitoring sensors, including PFMS 18 and/or powder source mass sensor 44. Data received from powder source mass sensor 44 indicates a mass flow of powder from powder source 42 to powder delivery device. Data from PFMS 18 indicates a mass flow of powder in powder stream 30 between powder delivery device 14 to adjacent melt pool 32.

Computing device 12 may calculate one or more mass flow-related metrics based on the data received from PFMS 18 and powder source mass sensor 44. For example, one or more computing devices 12 may determine a capture efficiency by determining a fraction or percentage of powder from powder stream 30 that is captured by melt pool 32 and added to component 22, e.g., by dividing the powder mass captured by melt pool 32 into the mass flow determined based on data received from PFMS 18. Further, computing device 12 may determine an overall mass flux using the data received from PFMS 18 and/or powder source mass sensor 44. One or more computing devices 12 then may use the overall mass flux as an input to the control algorithm used to control the powder feed rate output by powder source 42 (see top left of FIG. 2).

Similarly, computing device may be configured to control energy delivery device 16 to deliver energy beam 34 to first layer 24 to establish a given heat input (see bottom left of FIG. 2). For example, one or more computing device 12 may control one or more operating parameters of energy delivery device 16, such as intensity, pulse rate, pulse width, or the like; one or more positional parameters related to energy delivery device 16, such as dwell time at a location, a movement rate relative to first layer 24, an overlap between adjacent passes of energy 34 across first layer 24, a pause time between adjacent passes of energy 34 across first layer 24, or the like to control heat input to system 10 (e.g., to melt pool 32 and component 22).

Computing device 12 may be configured to receive data from one or more heat sensors, such as optical system 54 and/or MP monitor 15 of spatter monitoring system 48. Computing device 12 may determine a cooling rate and associated heat from using data from optical system 54 and may determine a heat input into component using a size and/or temperature of melt pool 32 as observed by MP monitor 15. Computing device 12 may be configured to determine an overall heat flux using these data. Computing device 12 may then use the overall heat flux as an input to the control algorithm used to control the energy delivery by energy delivery device 16 (see top left of FIG. 2).

Computing device 12 may be configured to monitor spatter through spatter monitoring system 48 to validate that system 10 is operating correctly. For example, spatter monitoring system 48 may capture image data using MP monitor 15 and off-axis camera 21. Computing device 12 may identify spatter in the captured image data and determine that the identified spatter in the captured image data exceeds a threshold for causing one or more deposition anomalies. Based on the spatter exceeding the threshold for causing one or more deposition anomalies, computing device 12 may determine that the identified spatter constitutes a spatter event. Based on the determined spatter event computing device 12 may control one or both of powder delivery device 14 and energy delivery device 16. For instance, computing device 12 may be configured to control a carrier gas flow rate, a powder mass flow rate, and/or a delivery nozzle angle of powder delivery device 14 and/or a focus, a power supplied, a pulse rate, a wavelength, or the like of energy beam 34 of energy delivery device 16 to end the spatter event. In this way, system 10 may include spatter monitoring by spatter monitoring system 48 to reduce or eliminate deposition anomalies and improve build quality of component 22. In some examples, computing device 12 may control powder delivery device and/or energy delivery device 16 based at least partially on output(s) from ML model 67, as will be further described below.

FIG. 1B is a conceptual block diagram illustrating example spatter monitoring sensors of spatter monitoring system 48 and spatter monitoring analysis and control modules of computing device 12 of additive manufacturing system 10. Computing device 12 may be communicatively coupled to spatter monitoring system 48, optical system 54, and PFMS 18 to receive data from spatter monitoring system 48, optical system 54, and PFMS 18.

Spatter monitoring system 48 includes one or more image sensors configured to capture image data representative of a portion of system 10. In some examples, the one or more image sensors may generate sensor data representative of spatter in the imaged portion of system 10, and send the sensor data to computing device 12. In the example of FIG. 1B, spatter monitoring system 48 includes MP monitor 15 and off-axis camera 21. MP monitor 15 is a thermal camera configured to capture infrared image data, and off-axis camera 21 is an image sensor configured to capture visual light data. However, spatter monitoring system 48 may include other image sensors that are configured to capture image data of other portions of system 10 (e.g., a different volume or a different focus) at the same or other modes. Computing device 12 may be configured to receive image data from the one or more image sensors of spatter monitoring system 48.

In addition to data from spatter monitoring system 48, computing device 12 may receive data indicative of various parameters related to powder flow, energy flow, gas flow, and the like of system 10. For example, PFMS 18 may be configured to detect one or more parameters of system 10 related to powder flow, generate sensor data, and send the sensor data to computing device 12. Sensor data from PFMS 18 may indicate a mass flow of powder in powder stream 30 between powder delivery device 14 to adjacent melt pool 32. Similarly, optical system 54 may detect one or more parameters related to energy flow, generate sensor data, and send the sensor data to computing device 12. Sensor data from optical system 54 may indicate a flow of energy in energy beam 34 between energy delivery device 16 and melt pool 32.

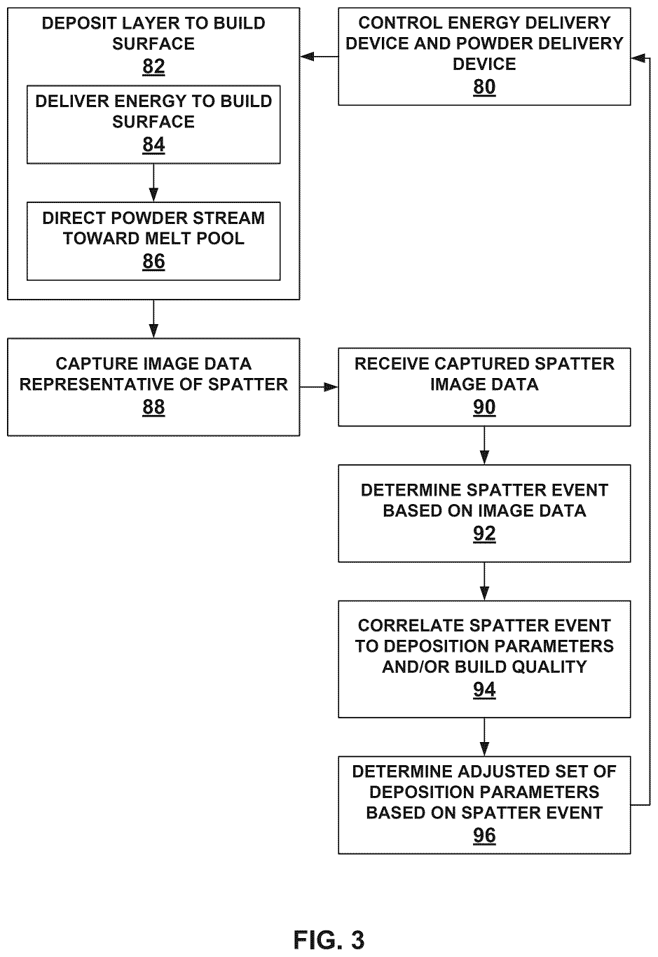

Computing device 12 is configured to analyze the sensor data, including the image data from spatter monitoring system 48, identify spatter in the image data, characterize and/or categorize a spatter evet based on the image data, and control fabrication of a component based on the characterized gas flow. Computing device 12 includes a spatter monitoring module 64, including a spatter event categorization module 65, and an adaptive control module 66, including a machine learning module 67. FIG. 3 is a flowchart illustrating an example additive manufacturing method for fabricating a component using image data from spatter monitoring system 48. Operation of computing device 12 will be described with respect to the method of FIG. 3. While computing device 12 will be described with respect to modules 64-67, it will be understood that various modules may be performed by other computing devices. For example, spatter monitoring module 64 and adaptive control module 66 may be part of separate computing devices, such as specialized computing devices for implementing spatter monitoring and/or modelling and machine learning techniques.

The method includes controlling energy delivery device 16 and powder delivery device 14 (80). Adaptive control module 66 is configured to control energy delivery device 16 and powder delivery device 14 according to a set of deposition parameters which, as will be described further below, are at least partly based on data from spatter monitoring system 48. For example, control module 66 may send control signals to energy delivery device 16 and powder delivery device 14 that control energy delivery device 16 and powder delivery device 14 to generate energy beam 34 and powder stream 30 according to particular parameters. As a result, energy delivery device 16 and powder delivery device 14 may deposit a layer on a build surface based on the control signals (82). For example, energy delivery device 16 may deliver energy to a build surface of a component to form a melt pool in the build surface of the component (84), and powder delivery device 14 may direct a powder stream toward the melt pool (86).

The method includes generating image data representative of spatter from spatter monitoring system 48 (88). For example, spatter monitoring system 48 may include MP monitor 15 that captures infrared image data and off-axis camera 21 that captures visual image data. MP monitor 15 and off-axis camera 21 may capture image data at particular periods to generate a temporal representation of spatter, such that the image data may approximate video data or other image data having a temporal component.

The method includes receiving image data indicative of spatter from spatter monitoring system 48 (90). In some examples, computing device 12 may receive the image data as powder delivery device 14 and energy delivery device 16 deliver powder stream 30 and energy beam 34, respectively, to build surface 28. For example, the image data may reflect local conditions of spatter in real time, such that computing device 12 may use the image data as immediate feedback. In some examples, computing device 12 may receive the sensor data after powder delivery device 14 and energy delivery device 16 deliver powder stream 30 and energy beam 34, respectively, to build surface 28. For example, the image data may reflect global conditions of spatter, such as for a particular layer or several layers, such that computing device 12 may use the image data as extended feedback for adjusting operation of powder delivery device 14 and/or energy delivery device 16 during a particular or subsequent build. In some examples, the method includes receiving additional sensor data, such as from at least one of optical system 54 or PFMS 18.

The method includes determining a spatter event based on the received image data (92). Spatter monitoring module 64 is configured to determine a spatter event based on the image data. For example, spatter monitoring module 64 may include spatter event categorization module 65, which may store image data related to prior spatter events, and resulting quality defects or the like resulting from each of the stored spatter events For examples, each previous spatter event stored in spatter event categorization module 65 may include a representation of a spatial, and optionally temporal, distribution of spatter near melt pool 32 of system 10 in the gas flow. Spatter monitoring module 64 may compare the received image data from spatter monitoring system 48 to the previous spatter events stored in spatter event categorization module, and may categorize the observe spatter as a particular type of spatter event. Spatter monitoring module 64 may generate a category for the spatter event, or may otherwise generate sufficient information from the image data for adaptive control module 66 to correlate characteristics of the spatter event with either/both deposition parameters that affect the spatter event or/and material parameters that are influenced by the spatter event.

In some examples, data associated with the spatter event may include parameters of powder delivery device 14 and energy delivery device 16. For examples, parameters of powder delivery device 14 may include data related to carrier gas flow, such as a velocity, directionality, and/or composition of the gases in the carrier gas flow. Parameters of powder delivery device 14 may further include a powder mass flow rate, powder size/distribution, and material in powder stream 30. Parameters of energy delivery device 16 may include a beam diameter of energy beam 16, a power supplied to energy delivery device or the like. Parameters may be sensed or determined by analyzing various properties of the image data, alone or in combination with other sensor or model data. Additionally, or alternatively, the parameters may be settings of various components of system 10. As will be described below, adaptive control module 66 may use one or more of these gas flow parameters as an input to a control algorithm used to control powder delivery device 14 and/or energy delivery device 16.

In some examples, the image data received from spatter monitoring system 48 may include relatively unprocessed or minimally processed image data that may reflect spatter in real-time. For example, the spatter image data may be a visual display of the image data in real-time or near real-time that may visually indicate spatter generated in response to a change in one or more deposition parameters of powder delivery device 14 and/or energy delivery device 16. In such examples, determining the spatter event based on the image data from spatter monitoring system 48 may include collecting and storing the image data in a form that can be optically analyzed for patterns at a set of deposition parameters or a change in patterns in response to a change in deposition parameters.

The method includes correlating the determined spatter event with deposition parameters that influence the gas flow and/or build quality (94). Adaptive control module 66 may be configured to correlate the gas flow with the deposition parameters and/or material parameters corresponding to build quality. For example, parameters of the carrier gas, powder flow, energy flow, or deposition head, such as the travel speed of the deposition head along a toolpath, may influence the spatter event (e.g., the amount, size, or distribution of spatter in the spatter event).

In some examples, adaptive control module 66 may correlate the spatter event with one or more deposition parameters controllable by powder delivery device 14 and/or energy delivery device 16. Adaptive control module 66 may be configured to analyze the spatter event with respect to deposition parameters and determine how a change in deposition parameters affects the spatter event. Particular spatter events may be associated with reduced build quality. For example, a turbulent gas flow at melt pool 32 may cause surface tension disruption at the surface of melt pool 32, which may cause spatter and thereby reduce build quality. Adaptive control module 66 may be configured to identify a surface tension disruption as indicated by the image data and the carrier gas flow rate. The image data and the carrier gas flow rate data may be used to analyze an effect of changing deposition parameters of powder delivery device 14 and/or energy delivery device 16.

In some examples, adaptive control module 66 may correlate the gas flow profile with one or more deposition anomalies. Deposition anomalies may include defects in the as-deposited layer 26 that may be indicated by the spatter event. For example, a particular spatter event may be differentiated and characterized, such that identification of the particular spatter event may indicate an increased likelihood of the deposition anomaly occurring. For example, a spatter event that includes spatter of a threshold size or concentration may meet a threshold for causing a topological defect on build surface 28 that will cause layer 24 and/or layer 26 to fall outside a specification window for thickness of the layer. In some examples, adaptive control module 66 is configured to determine whether the spatter event meets the threshold for corresponding to one or more deposition anomalies. Adaptive control module 66 is configured to control energy delivery device 16 and powder delivery device 14 to reduce a magnitude or occurrence of the one or more deposition anomalies. For example, as discussed above, adaptive control module 66 may be configured to determine how deposition parameters affect the spatter event. Such identified deposition parameters may be adjusted to produce a different spatter event or eliminate the spatter event altogether (e.g., no material added to melt pool 32 leaves melt pool 32). In other words, adaptive control module 66 may adjust to the deposition parameters to produce a desired gas flow profile or avoid an undesired gas flow profile.

In some examples, adaptive control module 66 may be configured to correlate the spatter event with one or more structural features of additive manufacturing system 10 or component 22. For example, particular structural features of additive manufacturing system 10, such as clamps, tools, or walls of an enclosure, or component 22, such as part geometry, may cause a spatter event. Adaptive control module 66 may be configured to identify changes in spatter caused by the structural features, such that any predicted spatter for similar structural features may be predicted and reduced or avoided.

In some examples, computing device 12 may be configured to use machine learning techniques to identify spatter, identify the identified spatter as correlating to a spatter event that deleteriously impacts build quality, correlate the identified spatter with one or more deposition parameters of system 10, and/or identify an effect of structural features of system 10 or component 22 on spatter. Such machine learning techniques may enable computing device 12 to adapt and optimize deposition parameters using the observed gas flow indicated by the image data.

In some examples, machine learning model 67 may be configured to correlate the image data with spatter. In some examples, machine learning model 67 may correlate the identified spatter with the one or more deposition parameters using one or more machine learning techniques. Machine learning module 67 may be configured to determine one or more deposition parameters based on observed behavior indicated by the image data using model-based reinforcement learning. Machine learning module 67 may be configured to learn a model of spatter behavior based on the image data and use this model to make decisions about an effect of one or more deposition parameters or change in one or more deposition parameters.

Machine learning module 67 may identify one or more deposition parameters related to powder delivery device 14 such as one or more of a carrier gas flow rate, a powder flow rate, or a delivery nozzle position, shape, or other parameter of powder delivery device 14. Similarly, machined learning model 67 may identify one or more deposition parameters related to energy delivery device 16 such as a power or focus of energy delivery device 16. Machine learning module 67 may further receive the image data form spatter monitoring system 48 and identify ways that a spatter event may be reduced (e.g., producing less spatter) or eliminated. For example, a spatter event that results in large droplets of spatter adhering to build surface may be associated with topological defects in the as-deposited layer. Machine learning module 67 may receive the spatter monitoring data from spatter monitoring system 48 for different sets of deposition parameters of energy delivery device 16 and powder delivery device 14. As described above, the spatter monitoring data may include any combination of image data, parameters determined from the image data, model data that at least partially incorporates the image data, or settings of various parts of system 10.

Machine learning model 67 may identify a machine learning algorithm that captures the relationship between the set of deposition parameters and the observed behavior as indicated by the gas flow profile. Models may include, but are not limited to, reinforcement learning models, such as deep reinforcement learning algorithms or traditional reinforcement learning algorithms. Machine learning model 67 may train the machine learning model using the gas flow profile. The model may learn the underlying patterns and relationships between the deposition parameters and the observed behavior as indicated by spatter. For example, machine learning model 67 may operate the model to improve a reward signal associated with the observed spatter behavior.

Machine learning model 67 may determine improved deposition parameters for a given set of conditions. For example, machine learning model 67 may use optimization methods, such as gradient-based methods or evolutionary algorithms, to tune the deposition parameters. Machine learning model 67 may further validate the model by analyzing spatter during fabrication of other layers and/or components.

Machine learning model 67 may be configured to correlate the spatter event with one or more deposition anomalies. Machine learning module 67 may be configured to determine one or more parameters of melt pool 32 and/or the as-deposited layer based on observed spatter behavior indicated by the image data using model-based reinforcement learning. Machine learning module 67 may be configured to learn a model of the spatter behavior based on the image data and use this model to make decisions about an effect of one or more material parameters or change in one or more material parameters.

Machine learning model 67 may identify one or more parameters that results from or are correlated with a spatter event. Machine learning model 67 may further receive sensor information that provides indication of such parameters, such as temperature data of melt pool 32, topological data indicative of the surface of build surface 28, a travel speed of a deposition head along a toolpath, or any other data that may provide an indication of deposition conditions affected by the spatter event. As described above, the data input into machine learning model 67 may include any combination of image data from spatter monitoring system 48, parameters determined from the image data, model data that at least partially incorporates the image data, other sensed data from system 10, or various settings of system 10.

Machine learning model 67 may identify a machine learning algorithm that captures the relationship between the material parameters resulting from the spatter event. Models may include, but are not limited to, reinforcement learning models, such as deep reinforcement learning algorithms or traditional reinforcement learning algorithms. Machine learning model 67 may train the machine learning model using the spatter event and previous spatter events. The model may learn the underlying patterns and relationships between the material parameters and the observed behavior as indicated by the spatter. For example, machine learning model 67 may operate the model to improve a reward signal associated with the observed spatter event.

Machine learning model 67 may determine improved deposition parameters for a given set of conditions. For example, machine learning model 67 may use optimization methods, such as gradient-based methods or evolutionary algorithms, to tune the deposition parameters. Machine learning model 67 may further validate the model by analyzing spatter events and spatter behavior during fabrication of other layers and/or components, and the resulting build quality that results from reduction or elimination of spatter events.

The method may include determining an adjusted set of deposition parameters based on the determined spatter event (96). Adaptive control module 66 may control powder delivery device 14 according to an adjusted set of deposition parameters that modify powder stream 30 based on the spatter event. Adaptive control module 66 may use correlations between the spatter event and the deposition parameters and correlations between the spatter event and the build quality to select a set of deposition parameters that modifies powder stream 30 and/or energy beam 34 to improve build quality and/or reduce or eliminate a spatter event. A spatter event may be considered reduced when a reduced number of spatter droplets are produced, or when the spatter droplets are reduced in size, or when a distance the spatter is ejected from melt pool 32 is reduced, or a combination of these. For example, adaptive control module 66 may generate control signals that cause powder delivery device 14 to modify any of a powder flow rate, a carrier gas flow rate, a delivery nozzle position or angle, or other parameter related to a velocity, directionality, or composition of the flow of powder stream 30 to achieve a powder stream that reduces or eliminates a spatter event. Similarly, adaptive control module 66 may generate control signals that cause energy delivery device 16 to modify any of a power, focus (beam diameter), working distance, pulse rate, dwell time, polarity, or other parameter related to a power, directionality, or wavelength of energy beam 34 to achieve an energy beam that reduces or eliminates a spatter event. In some examples, where powder delivery device 14 and energy delivery device 16 are parts of a common deposition head, the computing device may control the toolpath of the deposition head to account for spatter. For example, computing device 12 may adjust the toolpath to avoid (e.g., swerve around) a deposition anomaly. In some examples, computing device 12 may cause the deposition head to re-do (e.g., travel back over) a layer with only energy delivery device 16 activated and not powder delivery device 14 activated. In this way, energy delivery device 16 may deliver energy beam 34 to melt and smooth spatter adhered to a surface of component 22.

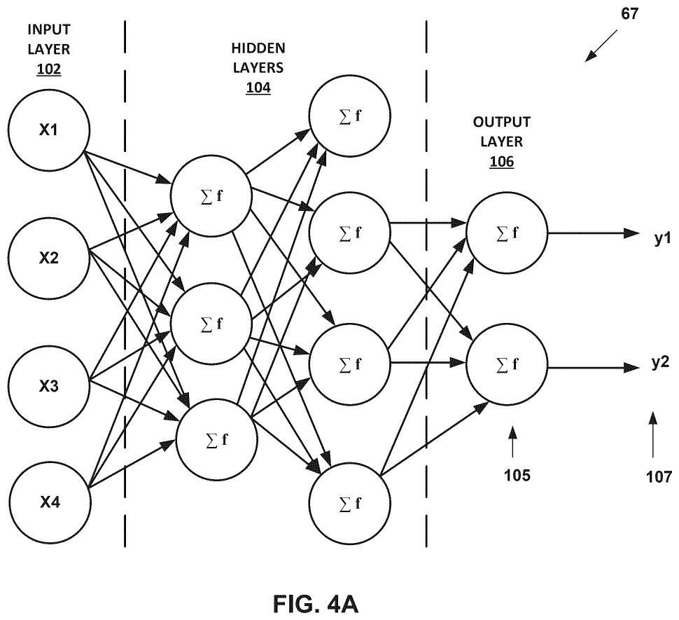

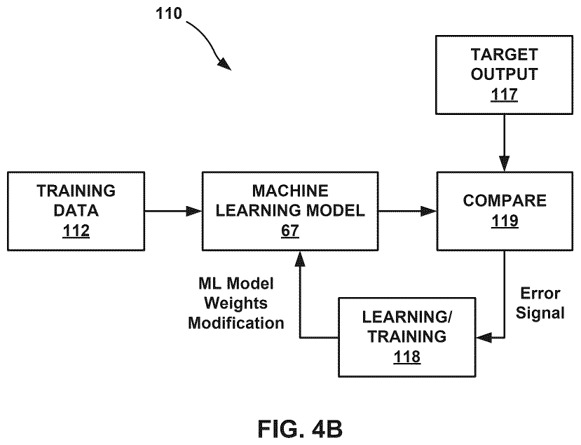

As explained in FIG. 1B with respect to machine learning model 67, additive manufacturing systems described herein may be configured to use machine learning processes for determining a relationship between a spatter event and various upstream deposition parameters that cause the spatter event or downstream parameters of component 22 that result from the gas flow profile. FIG. 4A is a conceptual diagram illustrating an example machine learning model according to one or more aspects of this disclosure. Machine learning model 67 may be an example of a deep learning model, or deep learning algorithm, trained to determine deposition parameters, material parameters, or structural features associated with or influenced by a spatter event. Computing device 12 and/or another device, may train, store, and/or utilize machine learning model 67, but other devices of system 10 may apply inputs to machine learning model 67. In some examples, other types of machine learning and deep learning models or algorithms may be utilized. For example, a convolutional neural network model of ResNet-18 may be used. Some non-limiting examples of models that may be used for transfer learning include AlexNet, VGGNet, GoogleNet, ResNet50, or DenseNet, etc. Some non-limiting examples of machine learning techniques include Support Vector Machines, K-Nearest Neighbor algorithm, and Multi-layer Perceptron.

As shown in the example of FIG. 4A, machine learning model 67 may include three types of layers. These three types of layers include input layer 102, hidden layers 104, and output layer 106. Output layer 106 includes the output from the transfer function 105 of output layer 106. Input layer 102 represents each of the input values X1 through X4 provided to machine learning model 67. In some examples, the input values may include any of the values input into the machine learning model, as described above. For example, the input values may include image data from spatter monitoring system 48, various settings and parameters of energy delivery device 14, various settings and parameters of energy delivery device 16, various parameters related to component 22, or another other data received by computing device 12, as described above.

Each of the input values for each node in the input layer 102 is provided to each node of a first layer of hidden layers 104. In the example of FIG. 4A, hidden layers 104 include two layers, one layer having four nodes and the other layer having three nodes, but fewer or greater number of nodes may be used in other examples. Each input from input layer 102 is multiplied by a weight and then summed at each node of hidden layers 104. During training of machine learning model 67, the weights for each input are adjusted to establish a relationship between image data from spatter monitoring system 48 and deposition parameters that generate spatter event represented by the image data. In some examples, one hidden layer may be incorporated into machine learning model 67, or three or more hidden layers may be incorporated into machine learning model 67, where each layer includes the same or different number of nodes.

The result of each node within hidden layers 104 is applied to the transfer function of output layer 106. The transfer function may be linear or non-linear, depending on the number of layers within machine learning model 67. Example non-linear transfer functions may be a sigmoid function or a rectifier function. The output 107 of the transfer function may be a set of deposition parameters, or a set of material parameters, that correspond to a gas flow profile depicted in the image data.

As shown in the example above, by applying machine learning model 67 to input data such as image data from spatter monitoring system 48, processing circuitry of computing device 12 is able to determine a relationship between deposition parameters that produce, material parameters the result from, and/or structural parameter that affect the spatter event based on image data. Computing device 12 may utilize such features to determine a local coordinate system, to map the local coordinate system to a global coordinate system, and/or to generate representations of the spatter event.

FIG. 4B is a conceptual diagram illustrating an example training process for a machine learning model according to one or more aspects of this disclosure. Process 110 may be used to train machine learning model 67. Machine learning model 67 may be implemented using any number of models for supervised and/or reinforcement learning, such as but not limited to, an artificial neural network, a decision tree, naïve Bayes network, support vector machine, or k-nearest neighbor model, CNN, RNN, LSTM, ensemble network, to name only a few examples.

In some examples, computing device 12 or another device trains machine learning model 67 based on a corpus of training data 112. Training data 112 may include, for example, image data of previous spatter events, previous image data of spatter that did not meet a threshold for being determined a spatter event (e.g., did not result in a deposition anomaly), previous deposition parameters or material parameter data, and/or the like. Previous deposition parameter or material parameter data, for example, may include deposition parameters or material parameters associated with previous additive manufacturing processes. In some examples, the image data and/or deposition parameter or material parameter data may be generated by executing a natural language processing application on content of a plurality of operational records to automatically extract relevant nor desired training data. For example, by using an NLP model, computing device 12 may capture potentially cofounding operation conditions or factors, which may be useful in determining a set of deposition parameters. Computing device 12 may use the NLP model to capture such details. In such an example, the machine learning model may analyze underlying characteristics associated with the powder, rather than powder flow factors, when determining a set of deposition parameters.

In some examples, training data 112 may include annotations identifying effects of deposition parameters indicated in image data of training data 112. Training data 112 may include data from past additive deposition processes performed on components having different geometries, formed from different materials, formed under different conditions, and/or the like.

While training machine learning model 67, computing device 12 may compare 119 a prediction or classification with a target output 117. Computing device 12 may utilize an error signal from the comparison to train (learning/training 118) machine learning model 67. Computing device 12 may generate machine learning model weights or other modifications which computing device 12 may use to modify machine learning model 67. For example, computing device 12 may modify the weights of machine learning model 67 based on the learning/training 118.

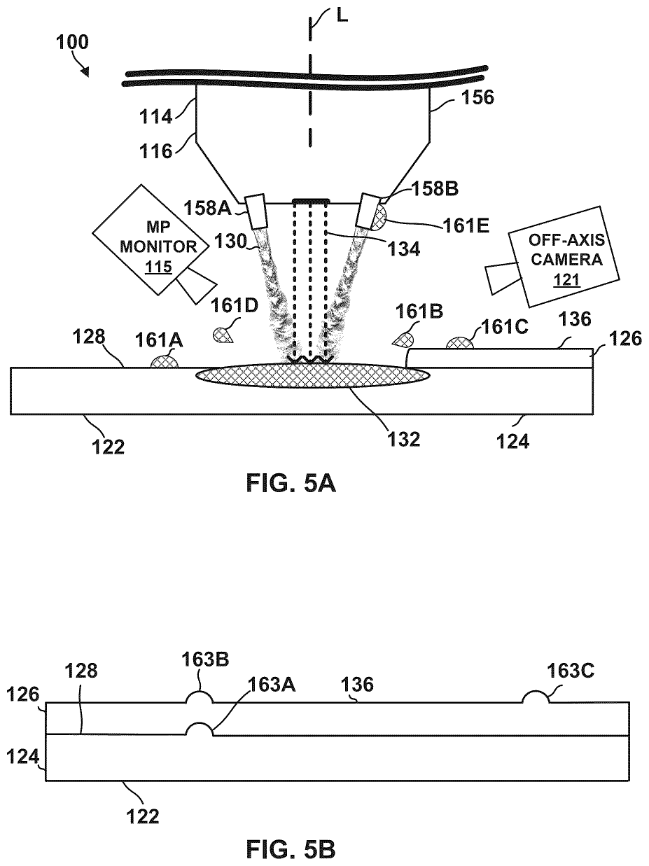

FIG. 5A is a conceptual and schematic diagram illustrating a portion of an example additive manufacturing system 100 during an additive manufacturing technique that does not use spatter monitoring. Additive manufacturing system 100 of FIG. 5A may be an example of additive manufacturing system 10 of FIGS. 1A and 1B. Similar reference numerals indicate similar elements. Portions of additive manufacturing system 100 are not included in FIG. 5A. These portions will be described with respected to additive manufacturing system 10 of FIGS. 1A and 1B.

Additive manufacturing system 100 includes deposition head 156, of which both energy delivery device 116 and powder delivery device 114 are components. In the illustrated example, energy delivery device 116 includes a laser mounted above or housed in a cavity within deposition head 156. Energy delivery device 116 delivers energy beam 134 through an opening in deposition head 156 to form melt pool 132 on build surface 128 of previously deposited layer 124 of component 122.

Powder delivery device 114 includes channels (not illustrated for clarity) formed within the wall of deposition head 156. The channels are fluidically connected to delivery nozzles 158A, 158B (collectively “delivery nozzles 158”) from which powder stream 130 is directed to melt pool 132, adding material to melt pool 132 to form layer 126. Layer 126 defines surface 136.

Additive manufacturing system 100 includes MP monitor 115 and off-axis camera 121, which may be portions of spatter monitoring system 48. MP monitor 115 may be a thermal camera configured to image melt pool 132 and the surrounding area, and off-axis camera 121 may be configured to capture visual light data of a broader portion of system 100, and may include within delivery nozzle 158B within the field of view. MP monitor 115 and off-axis camera 121 may be configured to capture and send image data to computing device 12 (e.g., periodically capture and send image data).

System 100 of FIG. 5A is illustrated with spatter monitoring functionally turned off for illustration of the impacts of spatter when a spatter event occurs. During the spatter event of FIG. 5A, spatter particles 161A-161E (collectively “spatter 161”) are ejected from melt pool 132. Spatter particle 161A adheres to build surface 128A at a location displaced from melt pool 132. Spatter particle 161E adheres to delivery nozzle 158B, where it may interfere with the deliver of powder stream 130 to melt pool 132, or may fall off at a later point in time and become adhered to build surface 128A. Spatter particle 161C adheres to surface 136 of as-deposited layer 126.

FIG. 5B is a conceptual and schematic side view diagram illustrating example additively-manufactured component 122 formed during the additive manufacturing technique of FIG. 5A. As illustrated spatter particle 161A, which adhered to build surface 128 during the process, may cool and harden to form topological defect 163A on build surface 128. Similarly, spatter particle 163C, which formed on surface 136 of layer 126 during the process, may cool and harden to form topological defect 163C on surface 136. Topological defect 163A may carry through as-deposited layer 126 to cause topological defect 163B. Topological defects 163 may be deposition anomalies that cause layer 124, layer 126, and/or component 122 to fall outside a deposition window. As such, forming component 122 with additive manufacturing system 100 without spatter monitoring and control may result in an low-quality build.

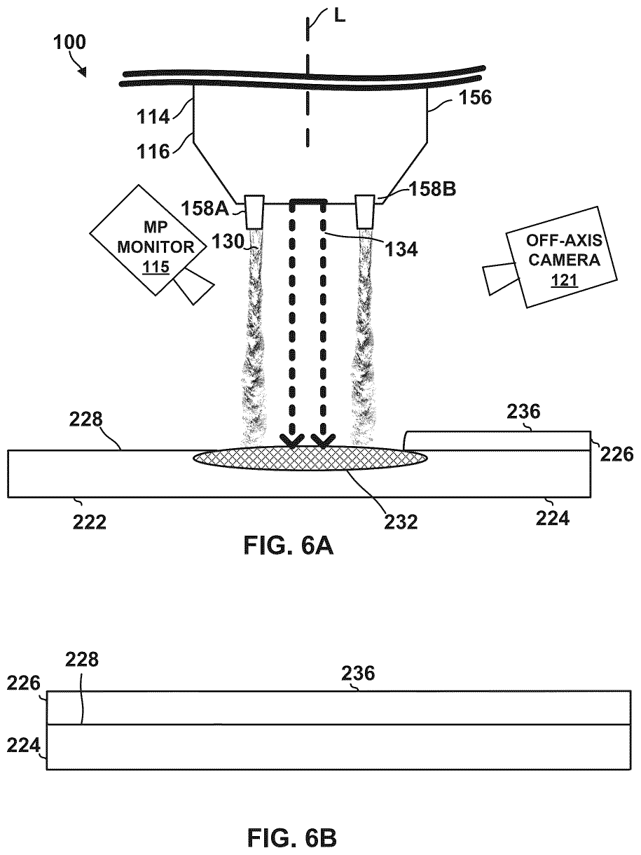

FIG. 6A is a conceptual and schematic diagram illustrating a portion of the example additive manufacturing system 100 during an additive manufacturing technique that employs spatter monitoring and control. Additive manufacturing system 100, when employing spatter monitoring and control as described herein, may form component 222 substantially free of defects related to spatter. For example, computing device 12 may adjust one or more parameters of system 100 to reduce or eliminate a spatter event to form component 222. As illustrated, relative to FIG. 5A, computing device 12 may adjust the working distance (e.g., distance between deposition head 156 and build surface 228 (illustrated by the greater distance powder stream 130 must traverse to enter melt pool 232 in FIG. 6A), the shape and power of energy beam 134 of FIG (illustrated by the darker lines of energy beam 134 in FIG. 6A), and/or the angle of delivery nozzles 158 (more perpendicular to build surface 228 in FIG. 6A), or the like. As illustrated, the adjusted parameters may result in no spatter. Accordingly, component 222 of FIG. 6B, fabricated by the manufacturing process that includes spatter monitoring and control of FIG. 6A, may include layers 224 and 226 that are substantially free from deposition anomalies due to spatter.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following examples and claims.

Example 1: An additive manufacturing system includes an energy delivery device configured to deliver energy to a build surface of a component to form a melt pool in the build surface of the component; a powder delivery device configured to direct a powder stream toward the melt pool; a spatter monitoring system configured to capture image data indicative of spatter, wherein spatter is material ejected from the melt pool; and a computing device configured to: receive the image data from the spatter monitoring system; identify, based on the received image data, a spatter event; and control at least one of the energy delivery device or the powder delivery device based on the identified spatter event.

Example 2: The additive manufacturing system of example 1, wherein, to identify the spatter event, the computing device is configured to: identify spatter in the received image data; and determine that the spatter identified in the received image data exceeds a threshold for causing one or more deposition anomalies to determine that the identified spatter constitutes the spatter event.

Example 3: The additive manufacturing system of any of examples 1 and 2, wherein the spatter monitoring system includes one or more off-axis image sensors.

Example 4: The additive manufacturing system of example 3, wherein the one or more off-axis image sensors include at least one thermal camera configured to capture infrared image data and one or more visual cameras configured to capture visual light data.

Example 5: The additive manufacturing system of any of examples 1 through 4,wherein the computing device is configured to control the powder delivery device according to a set of deposition parameters that includes one or more deposition parameters controllable by the powder delivery device, wherein the set of deposition parameters controllable by the powder delivery device include one or more of a carrier gas flow rate, a powder mass flow rate, and a delivery nozzle angle.

Example 6: The additive manufacturing system of example 5, wherein the computing device is further configured to: determine one or more deposition parameters controllable by the powder delivery device; and control, based on the one or more deposition parameters, the powder delivery device.

Example 7: The additive manufacturing system of any of examples 5 and 6, wherein the computing device is configured to determine, via a machine learning model that takes the image data from the spatter monitoring system as input, the one or more deposition parameters using one or more machine learning techniques.

Example 8: The additive manufacturing system of any of examples 1 through 7,wherein the computing device is configured to control the energy delivery device according to a set of deposition parameters that includes one or more deposition parameters controllable by the energy delivery device, wherein the set of deposition parameters controllable by the energy delivery device include one or more of a focus of the energy delivery device and a power supplied to the energy delivery device.

Example 9: The additive manufacturing system of example 8, wherein the computing device is further configured to: determine one or more deposition parameters controllable by the energy delivery device; and control, based on the one or more deposition parameters, the energy delivery device.

Example 10: The additive manufacturing system of any of examples 1 through 9,further comprising the component, wherein the component is a gas turbine engine component.

Example 11: A method for additive manufacturing includes delivering, via an energy delivery device of an additive manufacturing system, energy to a build surface of a component to form a melt pool in the build surface of the component; delivering, via a powder delivery device of the additive manufacturing system, a powder stream toward the melt pool, receiving, by a computing device, image data indicative of spatter from a spatter monitoring system of the additive manufacturing system, wherein spatter is material ejected from a melt pool formed on a component being manufactured by an additive manufacturing system; identifying, in the received image data, spatter; identifying, by the computing device and based on the spatter in the received image data, a spatter event; and controlling, by the computing device and based on the identified spatter event, at least one of the powder delivery device or the energy delivery device.

Example 12: The method of example 11, further includes determining, via the computing device, that the spatter event corresponds to one or more deposition anomalies; and controlling, via the computing device, the energy delivery device and the powder delivery device to reduce a magnitude or occurrence of the one or more deposition anomalies.

Example 13: The method of any of examples 11 and 12, further comprising capturing, via one or more off-axis image sensors of the spatter monitoring system, image data indicative of spatter.

Example 14: The method of example 13, wherein capturing image data indicative of spatter with one or more off-axis image sensors includes capturing infrared image data with a thermal camera and capturing visual light image data with a visual light camera.

Example 15: The method of any of examples 11 through 14, further comprising controlling the powder delivery device according to a set of deposition parameters that includes one or more of a carrier gas flow rate, a powder mass flow rate, and a delivery nozzle angle.

Example 16: The method of example 15, further includes determining, via the computing device, one or more deposition parameters controllable by the powder delivery device; and controlling, via the computing device and based on the one or more deposition parameters, the powder delivery device.

Example 17: The method of any of examples 15 and 16, further comprising determining, via a machine learning model housed by the computing device that takes the image data from the spatter monitoring system as input, the one or more deposition parameters using one or more machine learning techniques.

Example 18: The method of any of examples 11 through 17, further comprising controlling the energy delivery device according to a set of deposition parameters that includes one or more of a focus of the energy delivery device and a power supplied to the energy delivery device.

Example 19: The method of example 18, further includes determining, via the computing device, one or more deposition parameters controllable by the energy delivery device; and controlling, via the computing device and based on the one or more deposition parameters, the energy delivery device.

Example 20: The method of any of examples 11 through 19, further comprising recording, via the computing device, the determined spatter event as part of a quality plan for the component.

What is claimed is:

1. An additive manufacturing system, comprising:
an energy delivery device configured to deliver energy to a build surface of a component to form a melt pool in the build surface of the component;
a powder delivery device configured to direct a powder stream toward the melt pool;
a spatter monitoring system configured to capture image data indicative of spatter, wherein spatter is material ejected from the melt pool; and
a computing device configured to:
receive the image data from the spatter monitoring system;
identify, based on the received image data, a spatter event; and
control at least one of the energy delivery device or the powder delivery device based on the identified spatter event.

2. The additive manufacturing system of claim 1, wherein, to identify the spatter event, the computing device is configured to:
identify spatter in the received image data; and
determine that the spatter identified in the received image data exceeds a threshold for causing one or more deposition anomalies to determine that the identified spatter constitutes the spatter event.

3. The additive manufacturing system of claim 1, wherein the spatter monitoring system includes one or more off-axis image sensors.

4. The additive manufacturing system of claim 3, wherein the one or more off-axis image sensors include at least one thermal camera configured to capture infrared image data and one or more visual cameras configured to capture visual light data.

5. The additive manufacturing system of claim 1, wherein the computing device is configured to control the powder delivery device according to a set of deposition parameters that includes one or more deposition parameters controllable by the powder delivery device, wherein the set of deposition parameters controllable by the powder delivery device include one or more of a carrier gas flow rate, a powder mass flow rate, and a delivery nozzle angle.

6. The additive manufacturing system of claim 5, wherein the computing device is further configured to:
determine one or more deposition parameters controllable by the powder delivery device; and
control, based on the one or more deposition parameters, the powder delivery device.

7. The additive manufacturing system of claim 5, wherein the computing device is configured to determine, via a machine learning model that takes the image data from the spatter monitoring system as input, the one or more deposition parameters using one or more machine learning techniques.

8. The additive manufacturing system of claim 1, wherein the computing device is configured to control the energy delivery device according to a set of deposition parameters that includes one or more deposition parameters controllable by the energy delivery device, wherein the set of deposition parameters controllable by the energy delivery device include one or more of a focus of the energy delivery device and a power supplied to the energy delivery device.

9. The additive manufacturing system of claim 8, wherein the computing device is further configured to:
determine one or more deposition parameters controllable by the energy delivery device; and
control, based on the one or more deposition parameters, the energy delivery device.

10. The additive manufacturing system of claim 1, further comprising the component, wherein the component is a gas turbine engine component.

11. A method for additive manufacturing, comprising:
delivering, via an energy delivery device of an additive manufacturing system, energy to a build surface of a component to form a melt pool in the build surface of the component;
delivering, via a powder delivery device of the additive manufacturing system, a powder stream toward the melt pool,
receiving, by a computing device, image data indicative of spatter from a spatter monitoring system of the additive manufacturing system, wherein spatter is material ejected from a melt pool formed on a component being manufactured by an additive manufacturing system;
identifying, in the received image data, spatter;
identifying, by the computing device and based on the spatter in the received image data, a spatter event; and
controlling, by the computing device and based on the identified spatter event, at least one of the powder delivery device or the energy delivery device.

12. The method of claim 11, further comprising:
determining, via the computing device, that the spatter event corresponds to one or more deposition anomalies; and
controlling, via the computing device, the energy delivery device and the powder delivery device to reduce a magnitude or occurrence of the one or more deposition anomalies.

13. The method of claim 11, further comprising capturing, via one or more off-axis image sensors of the spatter monitoring system, image data indicative of spatter.

14. The method of claim 13, wherein capturing image data indicative of spatter with one or more off-axis image sensors includes capturing infrared image data with a thermal camera and capturing visual light image data with a visual light camera.

15. The method of claim 11, further comprising controlling the powder delivery device according to a set of deposition parameters that includes one or more of a carrier gas flow rate, a powder mass flow rate, and a delivery nozzle angle.

16. The method of claim 15, further comprising:
determining, via the computing device, one or more deposition parameters controllable by the powder delivery device; and
controlling, via the computing device and based on the one or more deposition parameters, the powder delivery device.

17. The method of claim 15, further comprising determining, via a machine learning model housed by the computing device that takes the image data from the spatter monitoring system as input, the one or more deposition parameters using one or more machine learning techniques.

18. The method of claim 11, further comprising controlling the energy delivery device according to a set of deposition parameters that includes one or more of a focus of the energy delivery device and a power supplied to the energy delivery device.

19. The method of claim 18, further comprising:
determining, via the computing device, one or more deposition parameters controllable by the energy delivery device; and
controlling, via the computing device and based on the one or more deposition parameters, the energy delivery device.

20. The method of claim 11, further comprising recording, via the computing device, the determined spatter event as part of a quality plan for the component.
